(19) United States
(12) Patent Application Publication
(10) Pub. No.: US 2011/0236095 A1
(43) Pub. Date: Sep. 29, 2011

(54) CLEANING BLADE AND IMAGE FORMING APPARATUS

(76) Inventor: Taku Aoshima, Kanagawa (JP)

(21) Appl. No.: 12/950,319

(22) Filed: Nov. 19, 2010

(30) Foreign Application Priority Data
Mar. 24, 2010 (JP) P2010-067778

(51) Int. Cl. G03G 21/00

(52) U.S. Cl. 399/350

(57) ABSTRACT

A cleaning blade includes a cleaning layer to face a image holding body and a back layer to be disposed at a side opposite to the image holding body and removes discharge products and developer residues that are stuck to a surface of the image holding body in such a manner that an edge of the cleaning layer comes into contact with the surface of the image holding body, and the back layer and the cleaning layer are molded integrally and a surface roughness Ra of the cleaning layer is lower than or equal to 0.12 μm.

### CROSS-REFERENCE TO RELATED APPLICATIONS

This application is based on and claims priority under 35 USC 119 from Japanese Patent Application No. 2010-067778 filed on Mar. 24, 2010.

### BACKGROUND

1. Technical Field

The present invention relates to a cleaning blade used in an image forming apparatus as well as to an image forming apparatus.

2. Related Art

In electrophotography-based apparatus such as copiers, printers, facsimile machines, and multifunction machines having the functions of these apparatus, residual developer that remains on the surface of a photoreceptor body is removed by a cleaning blade after transfer of a toner image from the photoreceptor body to a transfer subject medium or member. In recent years, it has come to be desired that the life of image forming units be elongated and cleaning blades be highly durable.

Conventional cleaning blades are of a single layer. And there is a problem that if a cleaning blade is made harder to increase the durability, the degree of frictional wear of a photoreceptor body is increased or the cleaning blade droops (a phenomenon that a tip portion of a cleaning blade droops when it is supported on one side).

### SUMMARY

According to an aspect of the invention, there is provided a cleaning blade which includes a cleaning layer to face a image holding body and a back layer to be disposed at the side opposite to the image holding body and which removes discharge products and developer residues that are stuck to a surface of the image holding body in such a manner that an edge of the cleaning layer comes into contact with the surface of the image holding body, characterized in that the back layer and the cleaning layer are molded integrally and a surface roughness Ra of the cleaning layer is lower than or equal to 0.12 μm.

### BRIEF DESCRIPTION OF THE DRAWINGS

Exemplary embodiments of the present invention will be described in detail based on the following figures, wherein:

FIG. 1 is a conceptual diagram of an image forming apparatus according to an exemplary embodiment;

FIG. 2 is a conceptual diagram of one of photoreceptor body units used in the exemplary embodiment;

FIG. 3 is a perspective view of a cleaning blade according to the exemplary embodiment and nearby members;

FIG. 4 is a perspective view of the cleaning blade according to the exemplary embodiment and nearby members;

FIG. 5 is an enlarged perspective view of the cleaning blade according to the exemplary embodiment and nearby members;

FIGS. 6A, 6B, 6C, 6D, 6E, 6F and 6G show how the cleaning blade according to the exemplary embodiment is fixed to a plate; FIG. 6A is a perspective view, FIG. 6B is a plan view, FIG. 6C is a view as viewed from the direction of arrow C in FIG. 6B, FIG. 6D is a view as viewed from the direction of arrow D in FIG. 6C, FIG. 6E is a view as viewed from the direction of arrow E in FIG. 6D, FIG. 6F is an enlarged view of important parts of FIG. 6D, and FIG. 6G is an enlarged view of part of FIG. 6E; and

FIG. 7 is a graph showing a relationship between the surface roughness of the cleaning blade and occurrence of streaks in Example of the invention,

Wherein 101 denotes transfer belt (transfer member), 103 denotes conveyance path (conveying unit), 104 denotes secondary transfer unit (transfer unit), 107 denotes fixing unit, 200 denotes photoreceptor body unit (image forming unit), 202 denotes transfer roll (transfer member), 210 denotes photoreceptor body (image holding body), 220 denotes cleaning unit, 221 denotes cleaning blade, 221a denotes back layer, 221b denotes cleaning layer and 221c denotes edge.

### DETAILED DESCRIPTION

An exemplary embodiment of the present invention will be hereinafter described with reference to the drawings.

### (1) Basic Configuration and Operations of Image Forming Apparatus

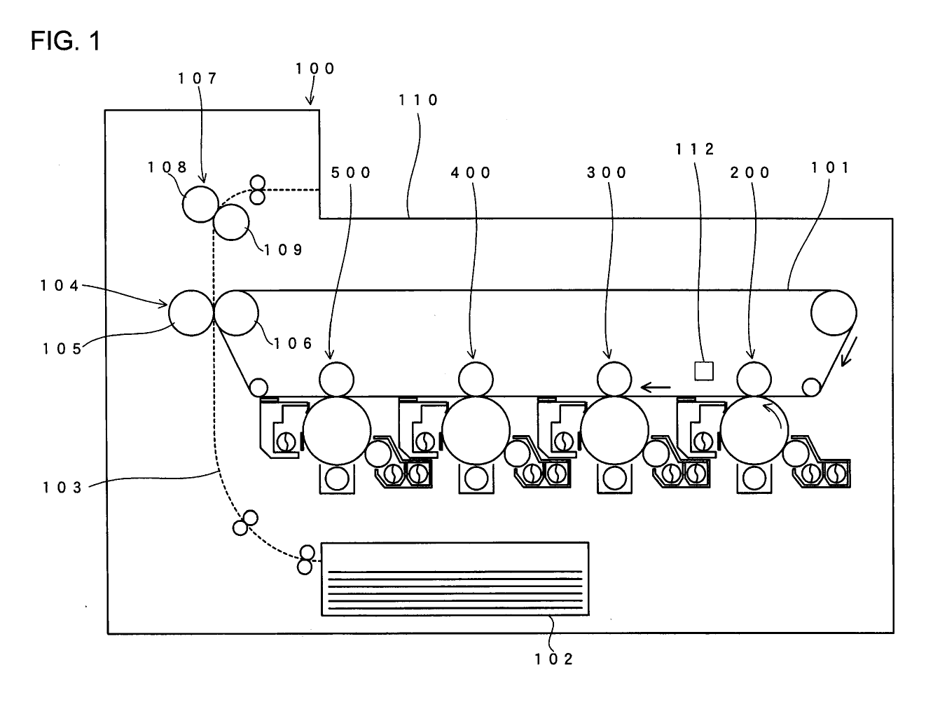

FIG. 1 shows an image forming apparatus 100 according to the exemplary embodiment, which is equipped with four photoreceptor body units 200, 300, 400, and 500. The four photoreceptor body units 200-500 transfer toner images of Y, M, C, and K to a transfer belt 101, respectively. The toner images are superimposed on each other on the transfer belt 101, whereby a color toner image is formed on the transfer belt 101.

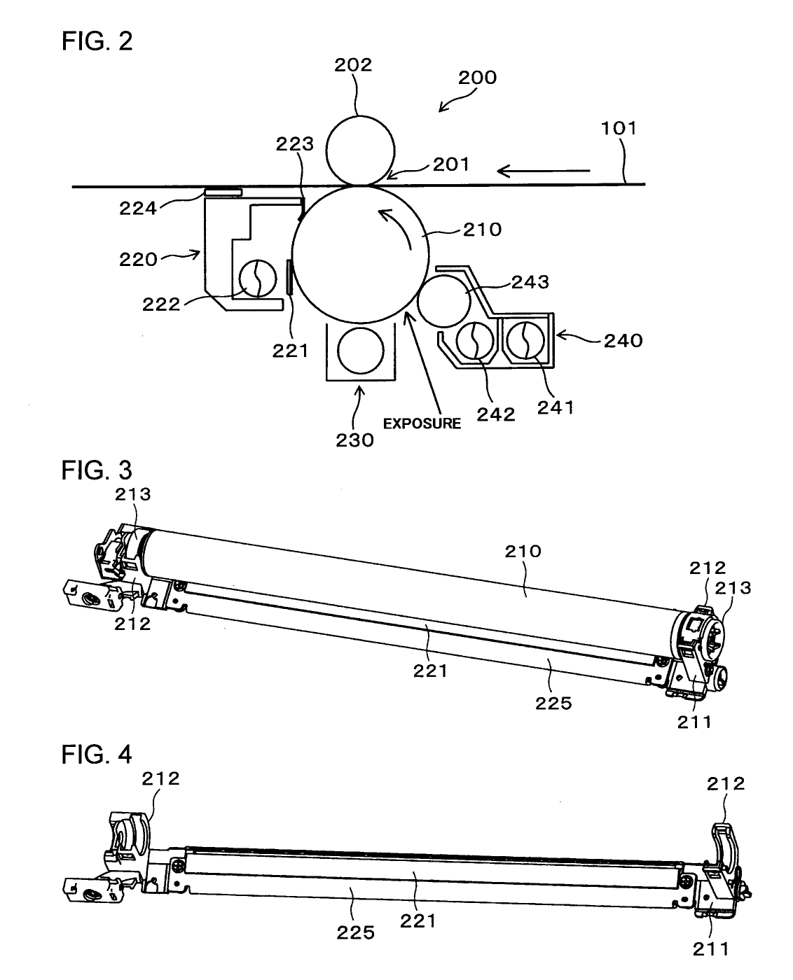

The four photoreceptor body units 200-500 have the same configuration except for toners used therein. The photoreceptor body unit 200 will be described below as a representative one. FIG. 2 shows the photoreceptor body unit 200, which is equipped with a cylindrical photoreceptor body 210 (example rotatable image holding body) which can be rotated counterclockwise (as viewed in FIG. 2). A cleaning unit 220, a charger 230, and a developing unit 240 are disposed around the photoreceptor body 210.

The cleaning unit 220 is equipped with a blade 221, an auger 222, a conductive contact member 223, and a charge removing member 224. The blade 221 is a plate-like member made of a urethane material and is in contact with the photoreceptor body 210. As the photoreceptor body 210 is rotated counterclockwise (as viewed in FIG. 2), residues remaining on the surface of the photoreceptor body 210 are removed by the edge of the blade 221. More specifically, as shown in FIG. 2, the photoreceptor body 210 is rotated counterclockwise (as viewed in FIG. 2) and the tip of the blade 221 contacts, from below, the surface portion, moving downward, of the photoreceptor body 210. In this manner, residues remaining on the surface of the photoreceptor body 210 are scraped off. The blade 221 also has a function of causing a lubricant that is supplied being contained in a developer to stick to the surface of the photoreceptor body 210 uniformly by rubbing the surface of the photoreceptor body 210. The blade 221 is an important feature of the exemplary embodiment and will be described later in detail.

The auger 222, which has a function of transporting a powder in the axial direction by means of its rotary spiral structure, transports residues that have been scraped off the surface of the photoreceptor body 210 to an ejection container (not shown). The conductive contact member 223 is in contact with the surface of the photoreceptor body 210 and collects charge remaining on the surface of the photoreceptor body 210. The charge removing member 224 neutralizes the charge collected by the conductive contact member 223.

The charger 230 produces charge by discharging and gives charge to (i.e., charges) a surface portion of the photoreceptor body 210 that has been cleaned and charge-removed by the cleaning unit 220.

Scanning light coming from an exposing device (not shown) passes between the charger 230 and the developing unit 240 and is applied to the surface of the rotating photoreceptor body 210. The surface of the photoreceptor body 210 that has been charged by the charger 230 is partially exposed to the light coming from the exposing device, whereby an electrostatic latent image is formed on the surface of the photoreceptor body 210.

The developing unit 240 is disposed downstream of the exposing region. The developing unit 240 is equipped with augers 241 and 242 and a developing roll 243. The augers 241 and 242 transport a developer which contains a toner and a lubricant from a container to the developing roll 243. The developing roll 243 supplies toner to the surface portion of the photoreceptor body 210 where the electrostatic latent image is formed and thereby develops it. A toner image is thereby formed on the surface of the photoreceptor body 210.

The developer contains the lubricant to be supplied to the surface of the photoreceptor body 210, and the developing unit 240 also functions as a lubricant supply unit. More specifically, the developer is such that powder of a lubrication auxiliary agent is stuck to toner particles, whereby the lubricant is supplied to the surface of the photoreceptor body 210 together with the toner. It is preferable that the lubrication auxiliary agent be a fluorine resin powder. The use of a polytetrafluoroethylene powder (a kind of fluorine resin powder) is particularly preferable because it is not prone to be separated from the toner and allows the lubricant to be supplied to the surface of the photoreceptor body 210 uniformly. It is preferable that the content of the lubrication auxiliary agent be 0.05 to 1 wt % with respect to the toner.

The toner image that has been produced by the developing unit 240 reaches a transfer position 201 as the photoreceptor body 210 is rotated counterclockwise (as viewed in FIG. 2). At the transfer position 201, a transfer roll 202 is opposed to the photoreceptor body 210 with the transfer belt 101 sandwiched in between. A bias voltage is applied between the photoreceptor body 210 and the transfer roll 202. The toner image is primarily transferred from the photoreceptor body 210 to the transfer belt 101 by the nipping pressure and the action of the bias voltage.

Returning to FIG. 1, the image forming apparatus 100 is equipped with a sheet housing unit 102 for housing sheets (sheet-like recording media). A sheet that is housed in the sheet housing unit 102 is conveyed to a secondary transfer unit 104 along a conveyance path 103. The secondary transfer unit 104 is equipped with a pressure roll 105 and a counter roll 106, between which the transfer belt 101 is sandwiched. A bias voltage is applied between the pressure roll 105 and the counter roll 106. The toner image formed on the transfer belt 101 is secondarily transferred, by the pressure and the action of the bias voltage, to the sheet that has been conveyed along the conveyance path 103 when the sheet is sandwiched between the transfer belt 101 and the pressure roll 105.

A fixing unit 107 is disposed downstream of the secondary transfer unit 104 which is located on the conveyance path 103. The fixing unit 107 is equipped with a heat roll 108 and a pressure roll 109. The toner image is fixed on the sheet when the sheet is sandwiched between the heat roll 108 and the pressure roll 109 and heat and pressure are applied to the sheet. The sheet on which the image has thus been formed is ejected to a sheet ejecting surface 110.

### (2) Structure of Cleaning Blade

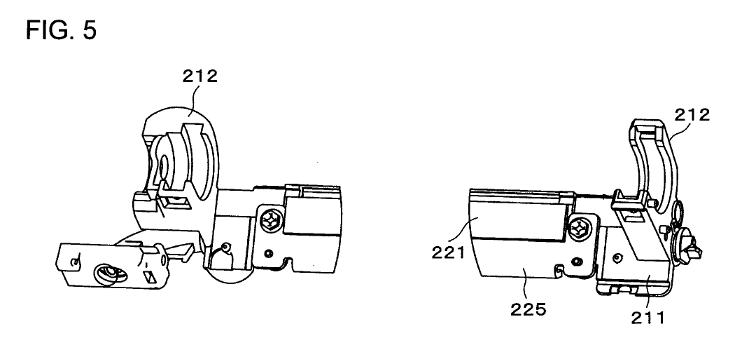

The cleaning blade according to the exemplary embodiment will be described below with reference to FIGS. 3 to FIGS. 6A-6G. In FIG. 3, reference numeral 211 denotes a frame which supports the photoreceptor body 210. Retainers are formed at the two respective ends of the frame 211, and a shaft (not shown) of the photoreceptor body 210 is supported rotatably by bearings 213 which are attached to the respective retainers 212.

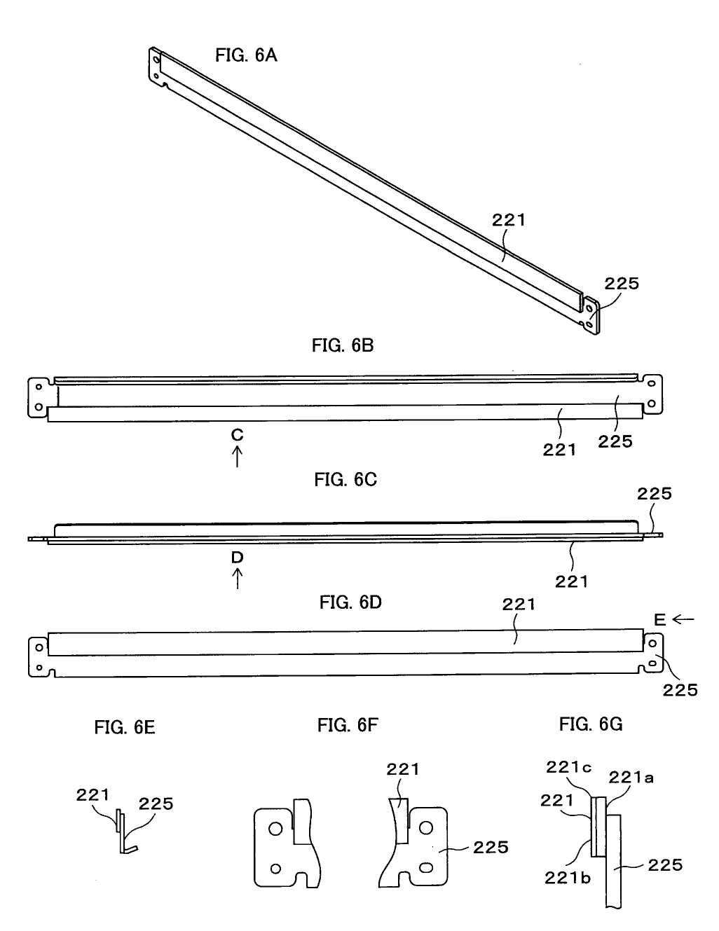

A metal plate 225 is attached to the frame 211, and the cleaning blade 211 is attached to the metal plate 225. As shown in FIG. 6G, the metal plate 225 is composed of a back layer 221a which is adhered to the plate 225 and a cleaning layer 221b which is laid on the back layer 221a. An edge 221c of the cleaning layer 221b is brought into contact with the surface of the photoreceptor body 210.

The back layer 221a and the cleaning layer 221b are molded integrally by centrifugal molding. First, a melted material of the back layer 221a is injected into a centrifugal molding drum and the centrifugal molding drum is rotated. As a result, the material of the back layer 221a is spread uniformly over the inner circumferential surface of the centrifugal molding drum and solidifies gradually. A melted material of the cleaning layer 221b is injected into the centrifugal molding drum before the material of the back layer 221a solidifies completely (i.e., in a state that the material is still tacky), and the material is caused to solidify as the centrifugal molding drum is rotated. A solidified material is taken out of the centrifugal molding drum and cleaning blades 221 are cut out.

An example material of the back layer 221a and the cleaning layer 221b is a polyurethane resin containing a polyol, polyisocyanate, etc. In particular, the user of a polyurethane resin containing a short-chain diol or a short-chain triol is preferable as a material of the back layer 221a because the back layer 221a should be smaller in Young's modulus than the cleaning layer 221b.

The surface of the cleaning layer 221b of the thus-molded cleaning blade 221 is formed with minute asperities. This is considered due to a phenomenon that asperities are formed at the interface between the back layer 221a and the cleaning layer 221b due to differences between the ways their materials behave when they solidify and cause formation of minute asperities in the surface of the cleaning layer 221b.

Such asperities appear in a wave-like manner in the edge 211c of the cleaning blade 221. The edge 221c is repeatedly subjected to a phenomenon (sticking) that it follows a rotating surface portion of the photoreceptor body 210 and a phenomenon (slipping) that it returns to the original posture. In a high-temperature, high-humidity environment, the edge 221c becomes more flexible and hence the edge 221c follows a rotating surface portion of the photoreceptor body 210 to a large extent (i.e., the area of a surface of the cleaning layer 221b that comes into contact with the surface of the photoreceptor body 210 is increased). On the other hand, in a low-temperature, low-humidity environment, the edge 221c becomes less flexible and hence the edge 221c follows a rotating surface portion of the photoreceptor body 210 to a small extent (i.e., the area of a surface of the cleaning layer 221b that comes into contact with the surface of the photoreceptor body 210 is decreased).

As described above, a surface, including the edge 221c, of the cleaning layer 221b comes into contact with the surface of the photoreceptor body 210, and the amount of lubricant (contained in the developer) that passes the edge 221c and contact force vary from one position to another on the surface of the photoreceptor body 210 depending on the surface asperities of the edges 221c. More specifically, when the edge 221b is pressed against the photoreceptor body 210, convex portions of a surface (including the edge 221c) of the cleaning layer 221b are in strong contact with the surface of the photoreceptor body 210 and the wear of the photoreceptor body 210 is accelerated there. On the other hand, concave portions of the surface of the cleaning layer 221b are in weak contact with the surface of the photoreceptor body 210 and more lubricant (contained in the developer) passes the edge 221c, resulting in an enhanced lubrication effect. Therefore, the wear of the photoreceptor body 210 is suppressed at positions corresponding to the concave portions and becomes much lower than the wear of the photoreceptor body 210 at the positions corresponding to the convex portions. As a result, thin portions and thick portions occur in the photoreceptor body 210. Larger currents flow through the thin portions in the thin portions and hence discharge loads are concentrated there, which further accelerates the wear there. This causes differences in the degree of development between high-wear portions and low-wear portions, as a result of which streaks are formed in an image in the rotation direction of the photoreceptor body 210. In the exemplary embodiment, the surface roughness Ra of the cleaning layer 221b is set lower than or equal to 0.12 μm. With this setting, the asperities of the surface of the cleaning layer 221b are such as to cause almost no differences in the degree of wear between individual portions of the photoreceptor body 210. Therefore, discharge loads are not concentrated and the formation of streaks in an image can be suppressed.

The surface roughness Ra of the cleaning layer 221b may be set lower than or equal to 0.12 μm by properly setting conditions of centrifugal molding. For example, the degree of waving of the material surface may be lowered by decreasing the rotation speed of the centrifugal molding drum or the influences of behaviors of the material of the back layer 221a during its solidification can be reduced by lowering the viscosity of the material.

With the cleaning blade 221 according to the exemplary embodiment, the degree of wear of the photoreceptor body 210 can be made uniform and hence the occurrence of streaks in an image can be suppressed which is due to differences in the degree of development on the photoreceptor body. In the exemplary embodiment, the cleaning blade 221 is molded by centrifugal molding. Alternatively, the cleaning blade 221 may be formed by applying a material of the back layer 221a to a base sheet by roll coating and applying a material of the cleaning layer 221b thereon also by roll coating.

### EXAMPLES

Cleaning blades are produced by integrally molding, by centrifugal molding, a cleaning layer of 0.5 mm in thickness, 78° in hardness, and 43% in impact resilience which is made of a polyurethane resin and a back layer of 1.4 mm in thickness, 63° in hardness, 0.5% in permanent set (elongation set), and 33% in impact resilience which is made of a polyurethane resin. Plural cleaning blades are produced that are different from each other in the surface roughness Ra of the cleaning layer.

Each of the thus-produced cleaning blades is mounted in an image forming apparatus. The edge of the cleaning blade is caused to cut into the photoreceptor body by 1.2 mm, and the angle formed by the cleaning blade and the tangential line of the surface of the photoreceptor body is set at 26°. Printing is performed on 7,000 A4-size sheets that are conveyed in the longitudinal direction in each of an environment of 28° C. in temperature and 85% in humidity and an environment of 10° C. in temperature and 15% in humidity. The number of rotations of the photoreceptor body is 215,000. A continuous printing operation on three sheets and a continuous printing operation on 50 sheets are performed alternately. As described above, in a high-temperature, high-humidity environment, the edge follows a surface portion of the photoreceptor body to a large extent and sticking and slipping of the edge are repeated at a high frequency. Asa result, the photoreceptor body is damaged seriously. On the other hand, in a low-temperature, low-humidity environment, the edge is harder and sharper and hence sticking and slipping of the edge are repeated at a low frequency. In this manner, in this Example, printing is performed in each of the environment in which the damage of the photoreceptor body is serious and the environment in which the damage of the photoreceptor body is light.

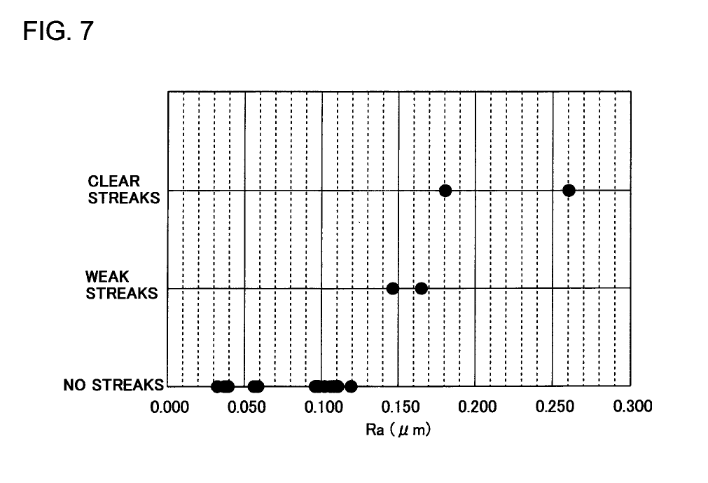

Printed sheets are checked visually for streaks extending in the rotation direction of the photoreceptor body. Results are shown in FIG. 7. As shown in FIG. 7, no streaks are found when the surface roughness Ra of the cleaning layer is lower than or equal to 0.12 μm. Weak streaks occur when the surface roughness Ra is equal to 0.147 μm, and clear streaks are found when the surface roughness Ra is equal to 0.18 μm.

Next, the image area ratio is set at 5% and a continuous printing operation on five A4-size sheets that are conveyed in the longitudinal direction is performed for a longtime. Results are as follows. In the case of cleaning blades whose surface roughness Ra of the cleaning layer is 0.14 to 0.18 μm, clear streaks occur when the number of rotations of the photoreceptor body reaches 450,000 to 600,000. On the other hand, in the case of cleaning blades whose surface roughness Ra of the cleaning layer is 0.05 to 0.07 μm, streaks remain weak even when the number of rotations of the photoreceptor body reaches 850,000.

The invention can be applied to image forming apparatus such as copiers, printers, facsimile machines, and multifunction machines having the functions of these apparatus.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A cleaning blade which comprises a cleaning layer to face a image holding body and a back layer to be disposed at a side opposite to the image holding body and which removes discharge products and developer residues that are stuck to a surface of the image holding body in such a manner that an edge of the cleaning layer comes into contact with the surface of the image holding body, wherein:
the back layer and the cleaning layer are molded integrally and a surface roughness Ra of the cleaning layer is lower than or equal to 0.12 μm.

2. The cleaning blade according to claim 1, wherein the back layer and the cleaning layer are molded integrally by supplying a material of the back layer and a material of the cleaning layer sequentially to a centrifugal molding drum.

3. The cleaning blade according to claim 1, wherein the cleaning layer is larger in Young's modulus than the back layer.

4. The cleaning blade according to claim 2, wherein the cleaning layer is larger in Young's modulus than the back layer.

5. An image forming apparatus comprising an image forming unit that forms a toner image, a transfer unit that transfers the toner image formed by the image forming unit to a recording sheet, a cleaning unit that removing developer residues that remain on a surface of an image holding body of the image forming unit, a fixing unit that fixes the toner image transferred to the recording sheet, and a conveying unit that conveys the recording sheet, wherein:
the cleaning unit comprises the cleaning blade according to claim 1.

6. An image forming apparatus comprising an image forming unit that forms a toner image, a transfer unit that transfers the toner image formed by the image forming unit to a recording sheet, a cleaning unit that removing developer residues that remain on a surface of an image holding body of the image forming unit, a fixing unit that fixes the toner image transferred to the recording sheet, and a conveying unit that conveys the recording sheet, wherein:
the cleaning unit comprises the cleaning blade according to claim 2.

7. An image forming apparatus comprising an image forming unit that forms a toner image, a transfer unit that transfers the toner image formed by the image forming unit to a recording sheet, a cleaning unit that removing developer residues that remain on a surface of an image holding body of the image forming unit, a fixing unit that fixes the toner image transferred to the recording sheet, and a conveying unit that conveys the recording sheet, wherein:
the cleaning unit comprises the cleaning blade according to claim 3.

8. An image forming apparatus comprising an image forming unit that forms a toner image, a transfer unit that transfers the toner image formed by the image forming unit to a recording sheet, a cleaning unit that removing developer residues that remain on a surface of an image holding body of the image forming unit, a fixing unit that fixes the toner image transferred to the recording sheet, and a conveying unit that conveys the recording sheet, wherein:
the cleaning unit comprises the cleaning blade according to claim 4.
